(19) United States
(12) Patent Application Publication
(10) Pub. No.: US 2007/0129044 A1
(43) Pub. Date: Jun. 7, 2007

(54) Power Saving System

(76) Inventor: Rui-Guang Chen, Taipei (TW)

Correspondence Address: LAW OFFICES OF LAI & ASSOCIATES, P.C.;STE 200, 5800 RANCHESTER, HOUSTON, TX, 77036, US

(21) Appl. No.: 11/566,112

(22) Filed: Dec. 1, 2006

(30) Foreign Application Priority Data
Dec. 1, 2005 (TW) 094220897

(51) Int. Cl. H04B 1/16

(52) U.S. Cl. 455/343.1

(57) ABSTRACT

A power saving system comprises a wireless apparatus and an electronic apparatus. The wireless apparatus is used to transmit a signal to the electronic apparatus through a wireless transmission protocol. The electronic apparatus controls a power saving mode based on the signal. The power saving mode indicates that at least a function unit of the electronic apparatus is shut down. The electronic apparatus executes the power saving mode to save power and enhance service life for components.

### FIELD OF THE INVENTION

The present invention relates to a power saving system, and more particularly to a wireless apparatus that remotely controls an electronic apparatus to perform a power saving mode.

### BACKGROUND OF THE INVENTION

Computers have become important tools for our daily life, since digital technology is in widespread use. Because functions provided by the computer are diversity, including word processing, data analysis, network search and home entertainments. Students and housewives may use the computer at any time. For most users, the computers are usually in boot state to avoid booting or shutting down again and again. When a user certainly does not use the computer, the computer then is shut down.

A power saving concept is developed due to environment protection reasons. Therefore, an operating system of the computer usually provides a power management function. When the user does not use the computer temporarily, the power state of components within the computer can be managed appropriately to avoid power waste and consuming the service life of components. Currently, manufacturers usually use an input interface of the computer corresponding to operating modes to manage powers of specific components, thereby achieving the goal of power saving.

Referring to FIG. 1, FIG. 1 is a block diagram illustrating a conventional keyboard for power control of components. The block diagram includes the keyboard 11, a power management mechanism 12, a shutdown mode 13, a sleep mode 14 and an end sleep mode 15. A function signal is inputted by the keyboard 11 based on functions selected by a user. The power management mechanism 12 then receives the signal to manage powers of specific components based on functions selected by the user such as the shutdown mode 13, the sleep mode 14 or the end sleep mode 15.

The current operating mode corresponds to hotkeys disposed upon the keyboard. The operating mode includes the shutdown mode, the sleep mode and the end sleep mode. Furthermore, the operating system may not easily handle the power controls of some components, for instance, a display screen of a notebook computer also consumes certain powers. An interface is applied for communication between users and the computer. If the users would like to change the operating mode, the user must execute application software first by moving a mouse for selecting the operating mode and then close the application software. However, the aforesaid way may cause inconvenience to the users in operating.

Therefore, the inventor of the present invention based on years of experience in related research and development, invents a power saving system to overcome the foregoing shortcomings.

### SUMMARY OF THE INVENTION

Briefly, the user must execute the application software by moving the mouse to select the operating mode and then closes the application software. This way causes great inconvenience. The object of the present invention is that a wireless apparatus is applied to control an electronic apparatus based upon different functions to allow the electronic apparatus to perform a power saving mode.

In accordance with a power saving system of the present invention the system includes an electronic apparatus and a wireless apparatus. A plurality of buttons on the wireless apparatus and a wireless transmission protocol are utilized to transmit a signal to allow the electronic apparatus to enter a power saving mode based on the signal. The electronic apparatus uses a receiving unit to receive the signal sent from the wireless apparatus for transmitting to a processor in order to perform a processing work. The processor sends a notice signal to a power controller based on an outcome of the processing work. The electronic apparatus then is controlled to enter a power saving mode. The power saving mode is that at least one function unit of the electronic apparatus enters a power off state. The wireless apparatus includes at least one power supplier like a battery for providing power required for the wireless apparatus. The wireless transmission protocol is an infrared transmission protocol or a Bluetooth transmission protocol or related or compatible transmission protocols. In addition, the wireless apparatus is a remote controller. The electronic apparatus is a notebook computer or a Personal Digital Assistant (PDA) or related electronic apparatuses. Therefore, the wireless apparatus is used to remote control the electronic apparatus. The electronic apparatus then performs the power saving mode to save power and to enhance service life for components.

Other features and advantages of the present invention and variations thereof will become apparent from the following description, drawings, and claims.

### BRIEF DESCRIPTION OF THE DRAWINGS

FIG. 1 is a block diagram illustrating a conventional keyboard for power control of components;

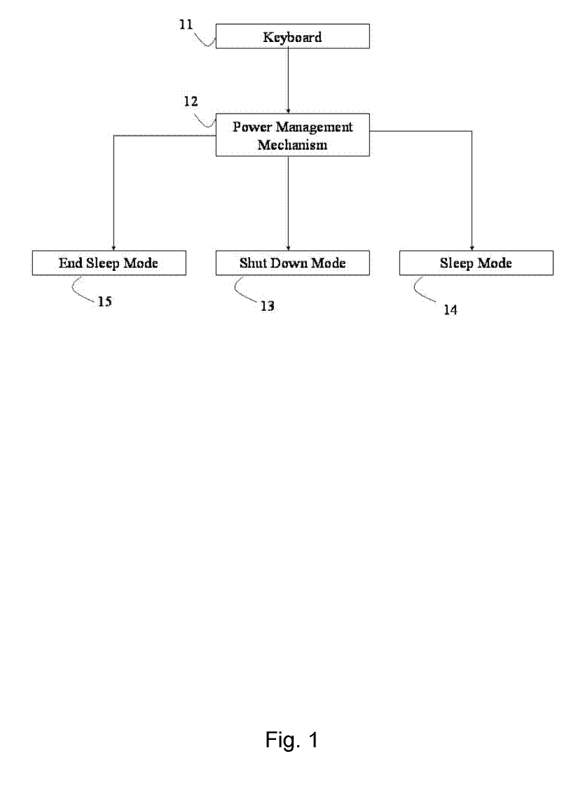

FIG. 2 is a schematic diagram illustrating a power saving system according to an embodiment of the present invention;

FIG. 3 is a block diagram illustrating an electronic apparatus according to an embodiment of the present invention;

FIG. 4 is a flowchart illustrating a method for power saving according to an embodiment of the present invention; and

FIG. 5 is a flowchart illustrating a method for power saving according to another embodiment of the present invention.

### DETAILED DESCRIPTION OF THE PREFERRED EMBODIMENTS

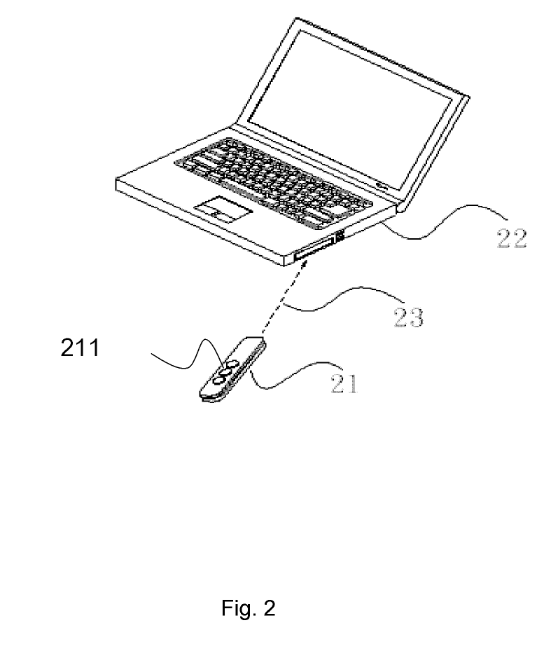

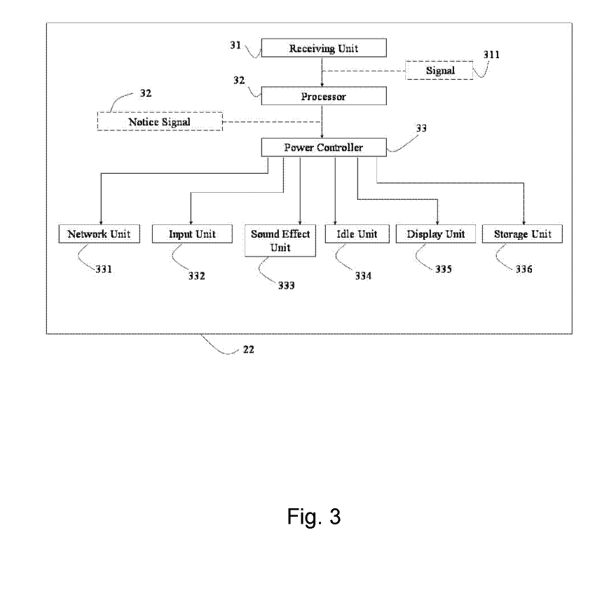

FIG. 2 is a schematic diagram illustrating a power saving system according to an embodiment of the present invention. FIG. 3 is a block diagram illustrating an electronic apparatus according to an embodiment of the present invention.

Referring to FIG. 2 and FIG. 3, as shown in FIG. 2, the power saving system includes a wireless apparatus 21 as a remote controller and an electronic apparatus 22 as a notebook computer. The wireless apparatus 21 has a plurality of buttons 211 that is controlled by a user. A wireless transmission protocol 23 as an infrared transmission protocol is used to transmit a signal 311 to the electronic apparatus 22. The wireless apparatus 21 uses a power supplier as a battery to provide power required for the wireless apparatus 21. The electronic apparatus 22 includes a plurality of function units and enters a power saving mode based on the signal 311. Referring to FIG. 3, the electronic apparatus 22 includes a receiving unit 31, a processor 32 and a power controller 33. The receiving unit 31 receives the signal 311 sent from the wireless apparatus 21. The signal 311 then is transmitted to the processor 32 to perform a processing work. The processing unit 32 then sends a notice signal to the power controller 33 to control at least one function unit of the electronic apparatus 22 to enter a power off state. Components entered the power off state can be a network unit 331, an input unit 332, a sound effect unit 333, an idle unit 334, a display unit 335 or a storage unit 336. The function of the electronic apparatus 22 includes word processing, data analysis, network search and home entertainments. Therefore, when the wireless apparatus 21 remotely controls the electronic apparatus 22, the electronic apparatus performs different power saving modes based upon different functions to save power and to enhance service life for components.

If a user would like to perform the functions of the electronic apparatus 22, the wireless apparatus 21 remotely controls the electronic apparatus 22. The network unit 331, the input unit 332, the sound effect unit 333 the idle unit 334, the display unit 335 or the storage unit 336 of the electronic apparatus 22 are then activated or enter the power off state.

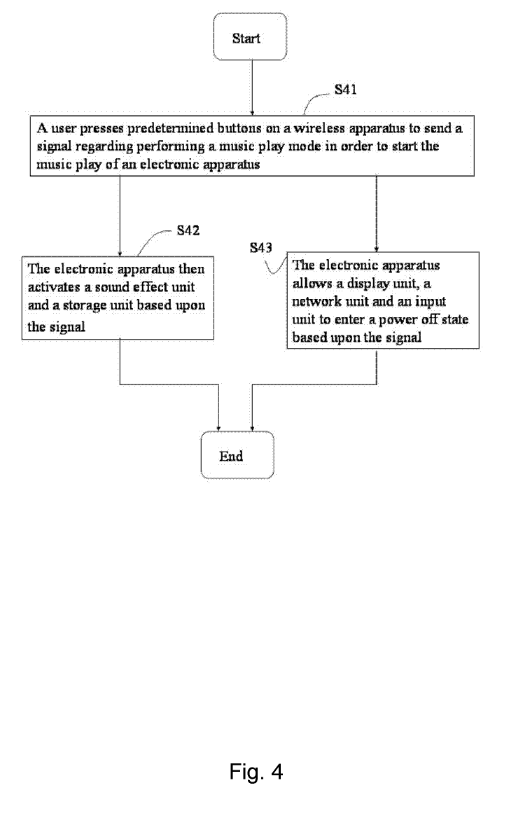

Referring to FIG. 4, a flowchart illustrates a method for power saving according to an embodiment of the present invention. The method includes the following steps:

Step S41: A user presses predetermined buttons on a wireless apparatus to send a signal regarding performing a music play mode in order to start the music play of an electronic apparatus.

Step S42: The electronic apparatus then activates a sound effect unit and a storage unit based upon the signal.

Step S43: The electronic apparatus allows a display unit, a network unit and an input unit to enter a power off state based upon the signal.

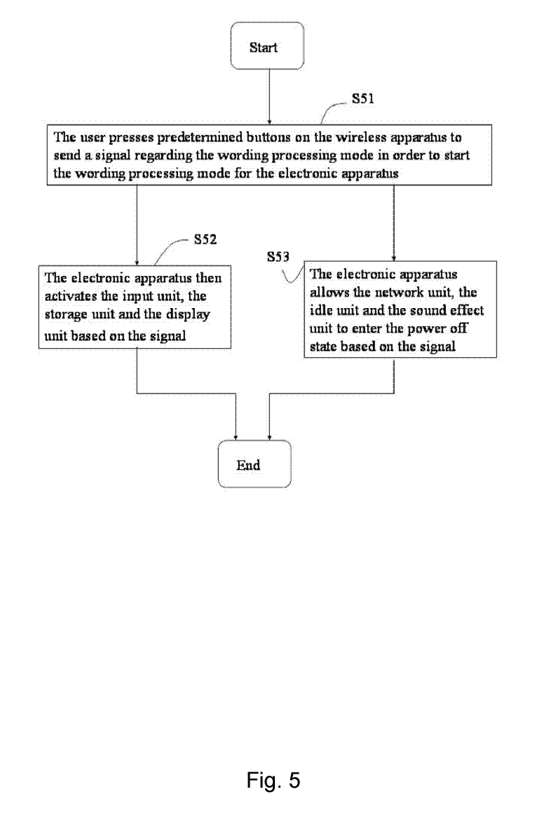

Referring to FIG. 5, a flowchart illustrates a method for power saving according to another embodiment of the present invention. There is, for instance, the wireless apparatus starts a word processing mode. The method includes the following steps:

Step S51: The user presses predetermined buttons on the wireless apparatus to send a signal regarding the wording processing mode in order to start the wording processing mode for the electronic apparatus.

Step S52: The electronic apparatus then activates the input unit, the storage unit and the display unit based on the signal.

Step S53: The electronic apparatus allows the network unit, the idle unit and the sound effect unit to enter the power off state based on the signal.

According to the aforesaid procedures, the power can be saved and the service life for components can be enhanced.

Although the features and advantages of the embodiments according to the preferred invention are disclosed, it is not limited to the embodiments described above, but encompasses any and all modifications and changes within the spirit and scope of the following claims.

What is claimed is:

1. A power saving system, comprising:
a wireless apparatus for transmitting a signal; and
an electronic apparatus having a plurality of function units, and for controlling a power saving mode based on said signal;
wherein said power saving mode is that at least one function unit of said electronic apparatus enters a power off state.

2. The power saving system of claim 1, wherein said wireless apparatus has a plurality of buttons.

3. The power saving system of claim 1, wherein said wireless apparatus uses a wireless transmission protocol for transmitting said signal.

4. The power saving system of claim 3, wherein said wireless transmission protocol is an infrared transmission protocol.

5. The power saving system of claim 1, wherein said wireless apparatus is a remote controller.

6. The power saving system of claim 1, wherein said wireless apparatus includes at least one power supplier for providing power required for said wireless apparatus.

7. The power saving system of claim 6, wherein said power supplier is a battery.

8. The power saving system of claim 1, wherein said electronic apparatus is a notebook computer.

9. The power saving system of claim 1, wherein said electronic apparatus uses a receiving unit for receiving said signal sent from said wireless apparatus.

10. The power saving system of claim 9, wherein said receiving unit transmits said signal to a processor to perform a processing work.

11. The power saving system of claim 1, wherein said function unit at said power off state is a network unit, an input unit, a sound effect unit, a display unit or a storage unit.
